(19) United States
(12) Patent Application Publication
(10) Pub. No.: US 2025/0291663 A1
(43) Pub. Date: Sep. 18, 2025

(54) INFORMATION PROCESSING APPARATUS

(71) Applicant: TOYOTA JIDOSHA KABUSHIKI KAISHA, Toyota-shi (JP)

(72) Inventors: Masafumi YAMAMOTO, Nagakute-shi (JP); Atsushi TABATA, Okazaki-shi (JP); Hideaki BUNAZAWA, Tokyo (JP); Koichi OKUDA, Toyota-shi (JP)

(73) Assignee: TOYOTA JIDOSHA KABUSHIKI KAISHA, Toyota-shi (JP)

(21) Appl. No.: 18/979,273

(22) Filed: Dec. 12, 2024

(30) Foreign Application Priority Data
Mar. 15, 2024 (JP) 2024-040813

(51) Int. Cl. G06F 11/07; G06F 18/23

(52) U.S. Cl. CPC G06F 11/0754; G06F 11/0739; G06F 18/23

(57) ABSTRACT

The processing device of the information processing apparatus includes: a first step of calculating a relative frequency distribution of the original data; a second step of setting a plurality of time windows for cutting out data of a part of the period of the original data; a third step of cutting out data from the original data; a fourth step of calculating a relative frequency distribution in the extracted data; and a fifth step of calculating an error between the relative frequency distribution in the original data and the relative frequency distribution in the extracted data, and performs a search processing of repeatedly executing the trial from the second step to the fifth step by changing the setting of the plurality of time windows.

### CROSS-REFERENCE TO RELATED APPLICATION

This application claims priority to Japanese Patent Application No. 2024-040813 filed on Mar. 15, 2024, incorporated herein by reference in its entirety.

### BACKGROUND

### 1. Technical Field

The disclosure relates to an information processing apparatus.

### 2. Description of Related Art

Japanese Unexamined Patent Application Publication No. 2008-108247 (JP 2008-108247 A) discloses an information processing apparatus that reduces size of data for analysis by compressing original data for analysis. The original data for analysis is data collected over a predetermined period using a sensor installed in a vehicle.

The information processing apparatus disclosed in JP 2008-108247 A compresses data by extracting, from the original data, data acquired at a point in time when a certain vehicle speed is reached and data acquired at the time of an inflection point of vehicle speed.

### SUMMARY

The above information processing apparatus extracts data by focusing only on the vehicle speed. Accordingly, the above information processing apparatus cannot extract data according to features of data other than the vehicle speed. There is demand for an information processing apparatus that can obtain extracted data that grasps features of the entirety of the original data, including feature quantities other than the vehicle speed.

An information processing apparatus for solving the above problem acquires original data, created by collecting over a predetermined period using a sensor installed a vehicle, and extracts data used for calculating a level of damage indicating a magnitude of damage accumulated in a lock-up clutch of a torque converter from the original data. This information processing apparatus includes a processing device that executes processing. The original data includes data of slip revolution speed of the lock-up clutch of the torque converter as a feature quantity. In this information processing apparatus, search processing executed by the processing device includes a first step of calculating relative frequency distribution in the original data regarding the feature quantity included in the original data for each of the feature quantities. The search processing includes a second step of setting a plurality of time windows for cutting out data for a part of a period of the original data such that a period obtained by totaling periods of all of the time windows is shorter than the predetermined period. The search processing includes a third step of cutting out data from the original data using the time windows. The search processing includes a fourth step of calculating the relative frequency distribution in extracted data obtained by combining the data cut out using the time windows for each of the feature quantities. The search processing includes a fifth step of calculating error between the relative frequency distribution in the original data and the relative frequency distribution in the extracted data. After the first step is executed, the processing device executes the search processing in which attempts of the second step to the fifth step are repeatedly executed while settings of the time windows are changed, and the extracted data in which the error is no greater than a threshold value is extracted.

In one aspect of the processing device, the processing device executes clustering that is machine learning to classify data in sections, obtained by dividing the original data for each certain period, into a predetermined number of clusters. The processing device sets the time windows in the second step such that a difference between a ratio of each cluster in the extracted data and a ratio of each cluster in an entirety of the original data is no greater than a threshold value.

This information processing apparatus can extract extracted data of which the amount of data is less than that of the original data, and from which analysis results are obtained with an accuracy equivalent to that of the original data. Thus, the information processing apparatus can realize, with regard to extracted data, both of reduction in the amount of data from that of the original data, and maintaining accuracy.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a relationship between a data center, a vehicle, and an information processing terminal, which is an embodiment of an information processing apparatus;

FIG. 2 is a schematic view of a vehicle comprising a lock-up clutch of a torque converter;

FIG. 3 is a graph showing the original data, the upper figure showing the transition of the slip revolution speed of the lock-up clutch, the middle figure showing the transition of the continuous slip time of the lock-up clutch, and the lower figure showing the transition of the temperature predicted value of the lock-up clutch;

FIG. 4 is a flowchart illustrating a flow of processing executed by the processing device of the data center;

FIG. 5 is a graph showing an exemplary clustering of original data using two feature quantities; and

FIG. 6 is a graph showing an example of the relative frequency distribution in the original data, the above figure shows an example of the relative frequency distribution for the slip revolution speed, the middle figure shows an example of the relative frequency distribution for continuous slip time, the following figure shows an example of the relative frequency distribution for temperature prediction value.

### DETAILED DESCRIPTION OF EMBODIMENTS

### Configuration of Information Processing System

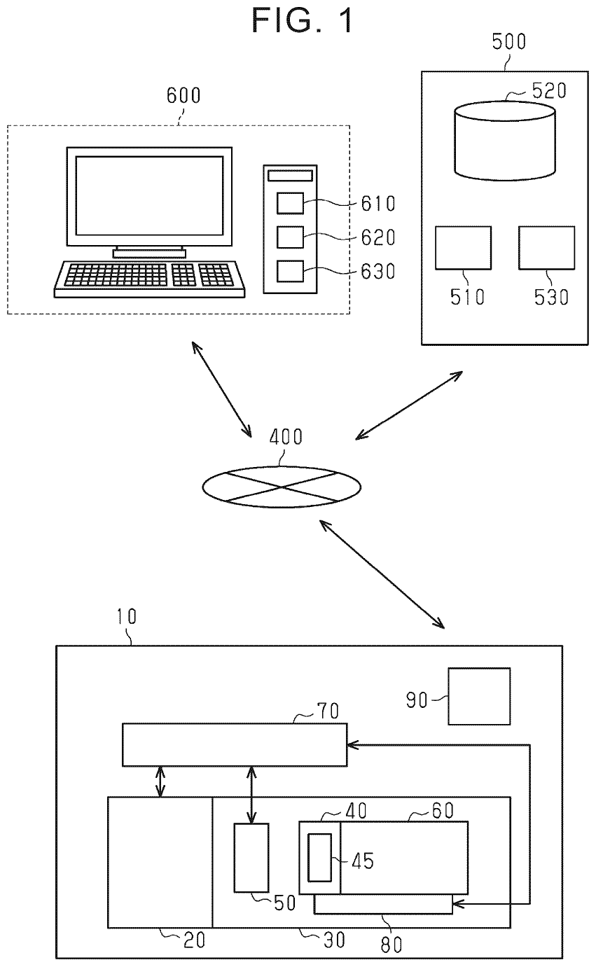

Hereinafter, a data center 500, which is an embodiment of an information processing apparatus, will be described with reference to FIG. 1 to FIG. 6.

FIG. 1 shows a configuration of an information processing system including a data center 500. As shown in FIG. 1, the data center 500 communicates with the vehicle 10 via a communication network 400. The data center 500 also communicates with the information processing terminal 600 via the communication network 400. The data center 500 communicates with the plurality of vehicles 10 and the plurality of information processing terminals 600 via the communication network 400.

### Configuration of the Data Center 500

As illustrated in FIG. 1, the data center 500 includes a processing device 510. The data center 500 includes a storage device 520 and a communication device 530. The processing device 510 includes a CPU that executes processing in accordance with a program, and a ROM in which the program is stored. The storage device 520 stores a large amount of data. The communication device 530 is implemented as hardware such as a network adapter, various communication software, or a combination thereof. The communication device 530 realizes wired or wireless communication via the communication network 400.

### Configuration of the Vehicle 10

The data center 500 may be configured using a plurality of computers. For example, the data center 500 may be configured by a plurality of server apparatuses. Each of the plurality of vehicles 10 includes a communication device 90. The communication devices 90 are implemented as hardware such as a network adapter, various types of communication software, or a combination thereof. The communication devices 90 are configured to realize wired or wireless communication via the communication network 400.

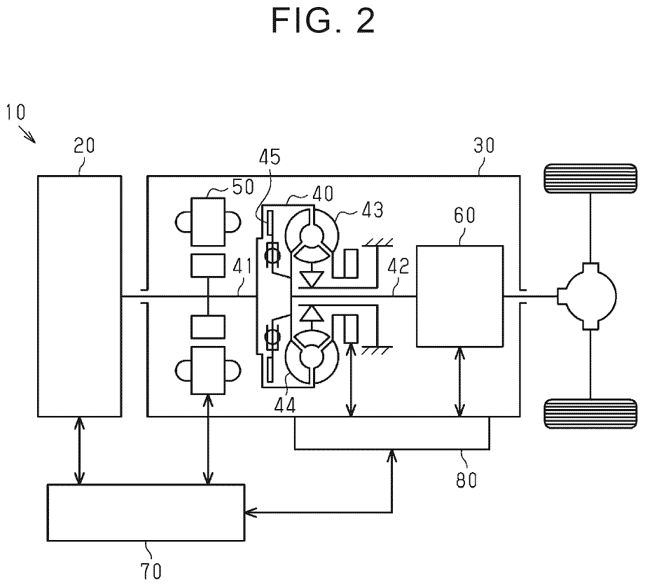

As shown in FIG. 2, each vehicle 10 is equipped with an engine 20 and a power transmission device 30 that transmits the torque of the engine 20 to the drive wheels of the vehicle 10. The power transmission device 30 includes a torque converter 40, a motor 50, and an automatic transmission 60.

The power transmission device 30 includes an input rotation shaft 41 that rotates integrally with the output shaft of the engine 20, and an output rotation shaft 42 that rotates integrally with the input shaft of the automatic transmission 60. In the power transmission device 30, the torque of the engine 20 is transmitted to the torque converter 40 via the input rotation shaft 41. Torque is also transmitted from the motor 50 to the input rotation shaft 41. In this way, the torque of the engine 20 and the motor 50 is transmitted to the torque converter 40. The torque transmitted to the torque converter 40 is output to the automatic transmission 60 via the output rotation shaft 42. The vehicle 10 is driven by the automatic transmission 60 transmitting the input torque of the engine 20 and the motor 50 to the drive wheels of the vehicle 10. In the automatic transmission 60, the gear stage is switched by the hydraulic pressure of the hydraulic oil.

The torque converter 40 is a fluid power transmission device. The torque converter 40 includes a pump impeller 43, a turbine impeller 44, and a lock-up clutch 45. The pump impeller 43 is connected to the input rotation shaft 41. The turbine impeller 44 is connected to an output rotation shaft 42. The lock-up clutch 45 directly connects the pump impeller 43 and the turbine impeller 44. The lock-up clutch 45 is switched between a direct-coupled state and a non-direct-coupled state by the hydraulic pressure of the hydraulic oil. The direct connection state is a state in which the pump impeller 43 and the turbine impeller 44 rotate integrally. The non-direct connection state is a state in which power is not directly transmitted between the pump impeller 43 and the turbine impeller 44, and a difference may occur between the rotational speed of the pump impeller 43 and the rotational speed of the turbine impeller 44.

The vehicle 10 includes a control device 70. The control device 70 controls the engine 20 and the motor 50. The control device 70 controls the output torque of the engine 20 by controlling the throttle actuator, the fuel injection device, the ignition device, and the like of the engine 20. The control device 70 controls the output torque of the motor 50 by controlling an inverter circuit provided between the motor 50 and the battery of the vehicle 10.

The vehicle 10 includes a hydraulic control circuit 80. The hydraulic control circuit 80 can change the hydraulic pressure of the hydraulic oil supplied to the automatic transmission 60 and the lock-up clutch 45. The control device 70 controls the hydraulic control circuit 80. The control device 70 controls the automatic transmission 60 and the lock-up clutch 45 by changing the hydraulic pressure of the hydraulic oil supplied to the automatic transmission 60 and the lock-up clutch 45.

The control device 70 is equipped with various sensors that collect information of each unit of the vehicle 10.

In each vehicle 10, travel data is collected from the various sensors. The traveling data is transmitted from each vehicle 10 to the data center 500 by the communication device 90. For example, travel data including the travel distance, the position information, and the vehicle speed of each vehicle 10 is transmitted from each vehicle 10 to the data center 500. Identification information for identifying the respective vehicles 10 is also transmitted from the respective vehicles 10 to the data center 500 together with the traveling data.

The data center 500 stores the traveling data together with the received identification information in the storage device 520. In this way, traveling data of the plurality of vehicles 10 is accumulated in the storage device 520 of the data center 500. Configuration of the information processing terminal 600

As illustrated in FIG. 1, the information processing terminal 600 includes a processing device 610, a storage device 620, and a communication device 630. The processing device 610 includes a CPU that executes processing in accordance with a program, and a ROM in which the program is stored. The storage device 620 stores data. The communication device 630 is implemented as hardware such as a network adapter, various communication software, or a combination thereof. The communication device 630 realizes wired or wireless communication via the communication network 400. The information processing terminal 600 is, for example, a personal computer.

### Analysis of Travel Data of the Vehicle 10

The information processing terminal 600 is used to analyze travel data. When analyzing the traveling data, an instruction for executing the analysis is transmitted from the information processing terminal 600 to the data center 500. The processing device 510 of the data center 500 that has received the instruction performs analysis using a part of travel data among the enormous travel data stored in the storage device 520 of the data center 500. The travel data to be used is selected from the enormous amount of travel data stored in the storage device 520 in accordance with the purpose of analysis.

For example, the processing device 510 calculates a load applied to a specific component of the specific vehicle 10 based on travel data of the specific vehicle 10. The processing device 510 estimates the damage accumulated in the component based on the calculated load. For example, the processing device 510 calculates an index value indicating the magnitude of the damage accumulated in the lock-up clutch 45 of the torque converter 40 of the specific vehicle 10 based on the traveling data of the specific vehicle 10. The processing device 510 of the data center 500 outputs the calculated result by transmitting the calculated result to the information processing terminal 600. The information processing terminal 600 that has received the result displays the received result.

In order to perform such an analysis, the processing device 510 analyzes a large amount of travel data collected over a long period of time. Since the processing device 510 needs to perform an enormous amount of computation, it takes a long time to analyze.

Therefore, it is conceivable to extract the extracted data that captures the features of the entire original data from a large amount of travel data that is the original data. If such extracted data can be extracted, the processing device 510 can perform analysis in a shorter time by using the extracted data. For example, in the case of estimating the damage of the lock-up clutch 45 when the vehicle travels for 100,000 hours, the processing device 510 estimates the damage using the extracted data for 20000 hours extracted from the original data for 100,000 hours. Then, the processing device 510 multiplies the index value calculated from the extracted data for 20000 hours by 5 to calculate the index value of the damage of the lock-up clutch 45 when the vehicle travels for 100,000 hours.

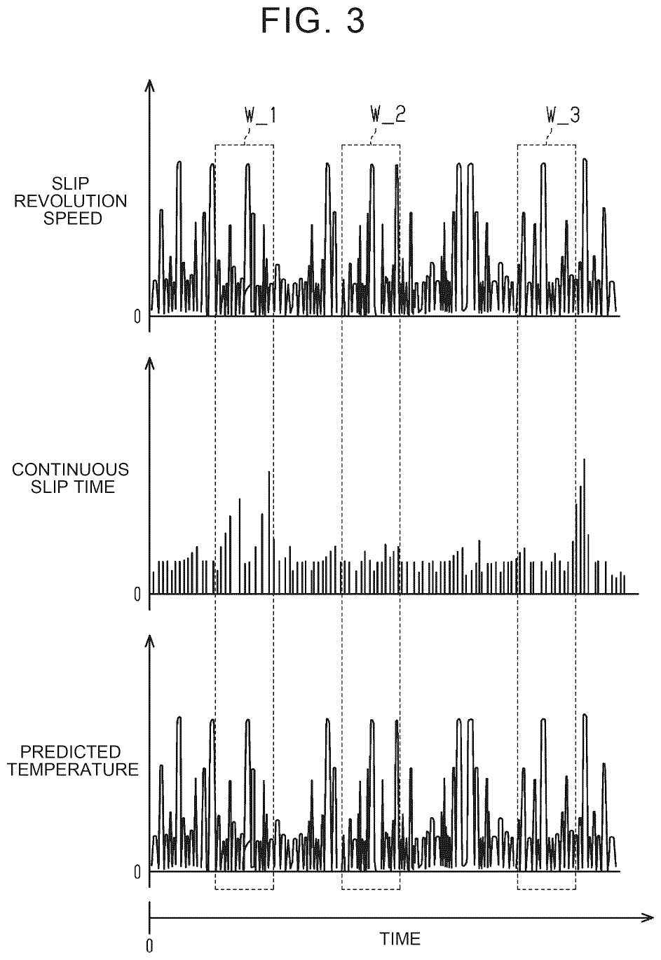

FIG. 3 illustrates an example of original data. The original data illustrated in FIG. 3 is travel data for 100,000 hours in one vehicle 10. The original data illustrated in FIG. 3 includes the slip revolution speed of the lock-up clutch 45 of the torque converter 40 as the feature quantity. The original data illustrated in FIG. 3 further includes a continuous slip time of the lock-up clutch 45 of the torque converter 40 as a feature quantity. The original data illustrated in FIG. 3 further includes, as the feature quantity, a temperature predicted value of the lock-up clutch 45 of the torque converter 40.

The top view of FIG. 3 shows the transition of the slip revolution speed of the lock-up clutch 45 for 100,000 hours. The slip revolution speed of the lock-up clutch 45 is a difference between the rotational speed of the output shaft of the engine 20 and the rotational speed of the input shaft of the automatic transmission 60. The control device 70 calculates the slip revolution speed from the rotation speed of the output shaft of the engine 20 and the rotation speed of the input shaft of the automatic transmission 60. The data of the rotational speed of the output shaft of the engine 20 and the rotational speed of the input shaft of the automatic transmission 60 may be transmitted from the vehicle 10 to the data center 500, and the slip revolution speed may be calculated in the data center 500.

The slip revolution speed is correlated with the damage of the lock-up clutch 45 of the vehicle 10. The processing device 510 of the data center 500 estimates the damage of the lock-up clutch 45 from the traveling data including the slip revolution speed as the feature quantity.

The middle diagram of FIG. 3 shows the transition of the continuous slip time of the lock-up clutch 45 for 100,000 hours. The continuous slip time of the lock-up clutch 45 is a time period from when the slip revolution speed becomes larger than 0 until when the slip revolution speed becomes 0 again. The control device 70 calculates the continuous slip time from the transition of the slip rotation. The continuous slip time may be calculated in the data center 500 from the transition of the slip revolution speed transmitted to the data center 500.

The lower diagram of FIG. 3 shows the transition of the predicted temperature value of the lock-up clutch 45 for 100,000 hours. The predicted temperature value of the lock-up clutch 45 is the oil temperature of the hydraulic oil supplied to the lock-up clutch 45. The oil temperature of the hydraulic oil supplied to the lock-up clutch 45 is output from the hydraulic control circuit 80 to the control device 70. The control device 70 acquires the predicted temperature value of the lock-up clutch 45 from the oil temperature of the hydraulic oil supplied to the lock-up clutch 45. The data of the oil temperature of the hydraulic oil supplied from the vehicle 10 to the lock-up clutch 45 may be transmitted to the data center 500, and the predicted temperature value may be acquired by the data center 500.

The continuous slip time and the predicted temperature are correlated with the damage of the lock-up clutch 45 of the vehicle 10. The processing device 510 of the data center 500 may estimate the damage of the lock-up clutch 45 from the traveling data including the continuous slip time and the temperature predicted value as the feature quantity in addition to the slip revolution speed.

The extracted data is created by clipping the data from the original data by a plurality of time windows. In FIG. 3, as an example of a plurality of time windows, three time windows of the first time window W_1, the second time window W_2, and the third time window W_3 are indicated by broken lines. The beginning and end of each time window are set such that the respective time windows do not overlap. In this example, the traveling data for 20000 hours is extracted as the extracted data. Therefore, the start and end periods of each time window are set so that the total length of the time periods of all the time windows is 20000 hours.

The data center 500 searches for the setting of the start time and the end time of each time window indicating the cut-out pattern for extracting the extracted data that captures the features of the entire original data.

The data center 500 extracts the extracted data from the original data by using the cut-out pattern found by the search. The data center 500 performs analysis using the extracted data.

### Search Processing for Cut Patterns

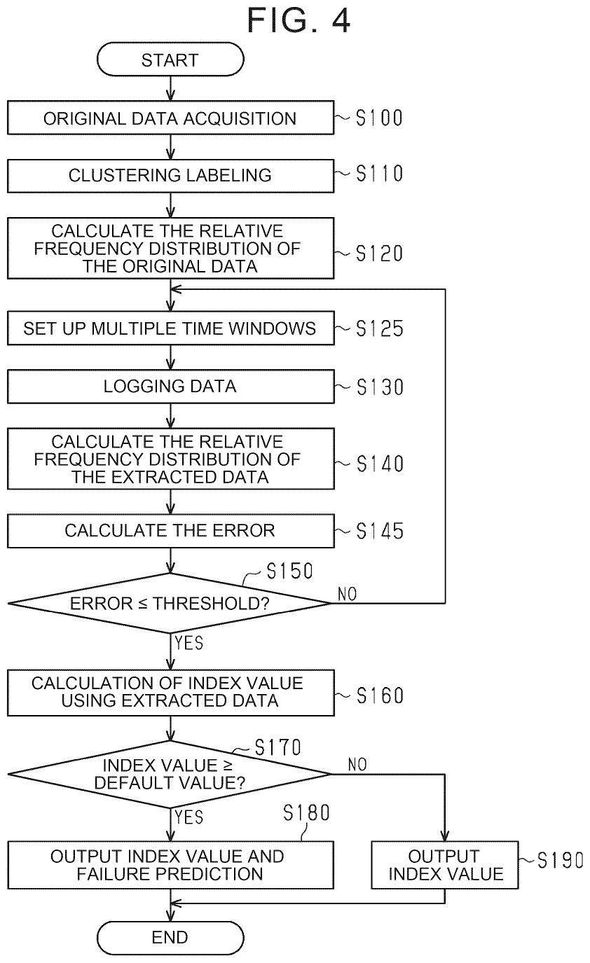

FIG. 4 is a flowchart illustrating a flow of a series of processes related to the extraction pattern search processing. This series of processing is executed by the processing device 510 of the data center 500.

As illustrated in FIG. 4, the processing device 510 acquires the original data in the processing of S100. The original data is a part of the travel data selected for the purpose of analysis from the enormous travel data stored in the storage device 520 of the data center 500. For example, the original data is travel data for a predetermined period of the target vehicle 10 selected from the enormous amount of travel data of the plurality of vehicles 10. The original data is data for calculating an index value indicating the magnitude of damage accumulated in the lock-up clutch 45 of the torque converter 40 of one vehicle 10. For example, in the case of estimating the damage of the lock-up clutch 45 when the vehicle travels for 100,000 hours, the original data is traveling data over a predetermined period of the target vehicle 10.

In S110 process, the processing device 510 labels the original data by clustering. Specifically, the processing device 510 divides the original data at regular intervals. The length of the period for separating the original data is, for example, several minutes. Then, the processing device 510 executes clustering which is machine learning for classifying the data of each section into a predetermined number of clusters. For example, k-means method is used as the algorithm of clustering. k-means method is a clustering algorithm for classifying data into a predetermined number of clusters. The clustering algorithm is not limited to k-means method.

The original data includes travel data collected under different environments, such as travel data when traveling in an urban area, travel data when traveling in a suburban area, and travel data when traveling on an expressway. By performing clustering, the travel data included in the original data can be classified into clusters of travel data having similar characteristics. The number of clusters to be classified is arbitrarily set according to the contents of the analysis.

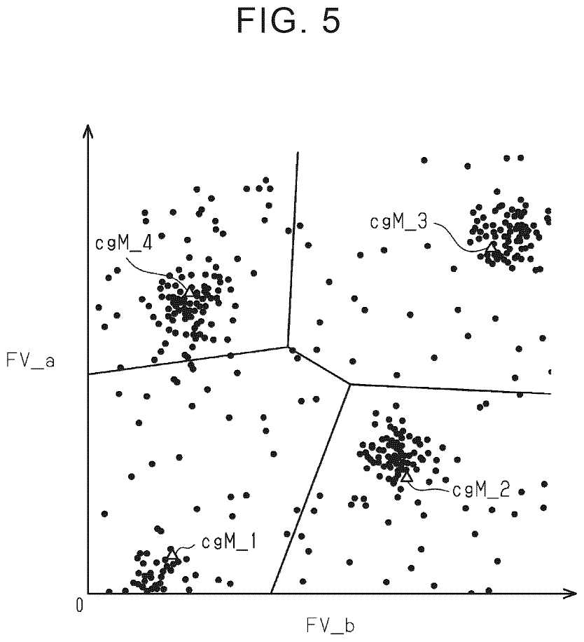

FIG. 5 is a graph illustrating an exemplary clustering of original data into four clusters by a k-means method using two feature quantities included in original data as explanatory variables. For example, the two feature quantities are the slip revolution speed and the continuous slip time illustrated in FIG. 3. In FIG. 5, each piece of data in each section partitioned from the original data is indicated by a single point. When performing clustering, the processing device 510 uses a representative value of an explanatory variable in the data of each section. For example, the processing device 510 sets the average value of the feature quantities in the data of each section as a representative value. The processing device 510 may use, as the representative value, the moving average value of the feature quantities in a plurality of consecutive sections in time series.

In FIG. 5, these points are shown in a two-dimensional space with the first feature quantity FV_a and the second feature quantity FV_b as coordinate axes. FIG. 5 is an example in which original data is clustered in four clusters of the first cluster M_1, the second cluster M_2, the third cluster M_3, and the fourth cluster M_4. In FIG. 5, the boundaries of the four clusters are indicated by solid lines. In FIG. 5, the center of gravity of each cluster is indicated by an open triangle. The center of gravity cgM_1 is the center of gravity of the first cluster M_1. The center of gravity cgM_2 is the center of gravity of the second cluster M_2. The center of gravity cgM_3 is the center of gravity of the third cluster M_3. The center of gravity cgM_4 is the center of gravity of the fourth cluster M_4.

Although FIG. 5 shows two examples of explanatory variables, the number of explanatory variables is not limited to two. For example, when the original data includes three feature quantities, the processing device 510 may perform clustering using these three feature quantities as explanatory variables. In this case, the processing device 510 clusters the original data in the three-dimensional space.

The processing device 510 assigns a label indicating the result of the clustering in this way to the original data. Specifically, each data indicated by a point in the coordinate space is given a label for identifying a cluster in which the data is classified. In this way, the processing device 510 creates the original data to which the label is attached.

Next, the processing device 510 calculates the relative frequency distribution of the original data in the processing of S120. When a plurality of feature quantities is included in the original data, the processing device 510 calculates a relative frequency distribution in the original data for each feature quantity.

The frequency distribution classifies data into a plurality of classes, and represents a frequency distribution that is the number of data of each class. The relative frequency indicates how much the frequency of the class accounts for the sum of the total frequencies.

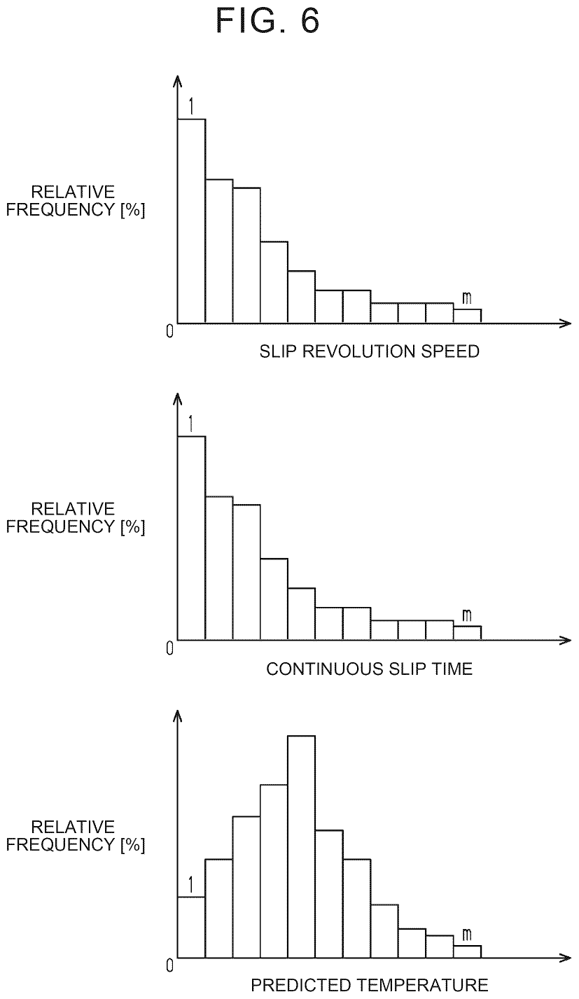

The upper diagram of FIG. 6 shows the relative frequency distribution for the slip revolution speed in the original data shown in FIG. 3. In this relative frequency distribution, the class of the slip revolution speed in the original data is divided into m classes from 1 to m, and the relative frequency distribution is shown.

The middle diagram of FIG. 6 shows the relative frequency distribution for the continuous slip time in the original data shown in FIG. 3. In this relative frequency distribution, the class of continuous slip time in the original data is divided into m classes from 1 to m, and the relative frequency distribution is shown.

The following figure of FIG. 6 shows the relative frequency distribution for the predicted temperature values in the original data shown in FIG. 3. In this relative frequency distribution, the class of the predicted temperature value in the original data is divided into m classes from 1 to m, and the relative frequency distribution is shown.

In S120 process, the processing device 510 calculates the relative frequency distribution for the respective feature quantities included in the original data. The number of classes in the relative frequency distribution of each feature quantity is the same.

Next, in S125 process, the processing device 510 sets a plurality of time windows in order to extract the extracted data from the original data.

In FIG. 3, three time windows W_1 to W_3 of the first time window W_1, the second time window W_2, and the third time window W_3 are shown as examples of a plurality of time windows. In the example shown in FIG. 3, the time periods of the respective time windows are all equal. As illustrated in FIG. 3, the data cut out by each cut-out window is data of each feature quantity in the same period.

In S125 process, the processing device 510 randomly sets a plurality of time windows such that the total time period of all time windows is shorter than a predetermined time period, which is the total time period of the original data. As will be described later, the processing device 510 combines all the data cut out by the plurality of time windows set here to generate extracted data. The total time period of all the time windows is a value for determining the capacity of the extracted data. Therefore, a period in which all the time windows are summed is set in advance.

For example, the processing device 510 randomly sets the number of time windows, the start of each time window, and the end of each time window each time S125 process is executed. At this time, the processing device 510 sets each time window so that each time window does not overlap. The processing device 510 thus randomly sets the plurality of time windows such that the total period of all time windows is a preset period. In S125 process, the processing device 510 may set a plurality of time windows by fixing the time periods of the time windows to be constant, as illustrated in FIG. 3. In S125 process, the processing device 510 may fix the plurality of time windows to a fixed number and set the plurality of time windows.

In addition to the above-described requirements, when setting a plurality of time windows through S125, the processing device 510 sets a plurality of time windows such that a difference between a ratio of each cluster in the extracted data and a ratio of each cluster in the entire original data is equal to or less than a threshold.

In this way, by setting a plurality of time windows through S125 processing, a cut-out pattern in which data is cut out from the original data is determined. When the processing device 510 determines the cut-out pattern in this way, the processing proceeds to S130.

In S130 process, the processing device 510 cuts out data from the original data in the determined cutout pattern. That is, in S130 process, the processing device 510 cuts out data from the original data by a plurality of set time windows. Then, the processing device 510 combines all the data cut out by the plurality of time windows to create extracted data.

In the process of the following S140, the processing device 510 calculates the relative frequency distribution of the extracted data. The processing device 510 calculates the relative frequency distribution of the extracted data in the same manner as the method of calculating the relative frequency distribution in S120. In other words, in S140 process, the processing device 510 calculates the relative frequency distribution of the extracted data for each feature quantity. At this time, the processing device 510 sets the number of grades in the relative frequency distribution of the respective feature quantities to be the same as the relative frequency distribution in S120.

### Mathematical Formula 1

Next, in S145 process, the processing device 510 calculates an error between the relative frequency distribution in the original data and the relative frequency distribution in the extracted data. For example, the processing device 510 calculates a mean absolute error MAE (Mean Absolute Error). The mean absolute error MAE is expressed by the following equation.

$$MAE = \frac{1}{n} {\sum }_{i = 1}^{n} {\sum }_{j = 1}^{m} \vert {Y}_{n m} - {y}_{n m} \vert$$

In the above equation, “n” is the number of feature quantities. “m” is the number of series in the relative frequency distribution. “Y” is the frequency of the corresponding feature quantity in the original data in the corresponding class. “y” is the frequency of the corresponding feature quantity in the extracted data in the corresponding class.

As shown in the above equation, the processing device 510 calculates, as an error, the sum of the errors of the frequencies in the respective classes for each feature quantity between the relative frequency distribution in the entire original data and the relative frequency distribution in the extracted data.

After calculating the error, the processing device 510 advances the processing to S150. In S150 process, the processing device 510 determines whether or not the calculated error is less than or equal to the thresholds. The threshold value is a value for determining whether or not the extracted data having the relative frequency distribution close to the relative frequency distribution in the original data is extracted by the set cutout pattern. The magnitude of the threshold is set in advance so that it can be determined that extracted data having a relative frequency distribution close to the relative frequency distribution in the original data is extracted based on the error being equal to or smaller than the threshold.

In S150 process, when it is determined that the error is equal to or smaller than the threshold (S150: YES), the processing device 510 advances the process to S160. In S160 process, the processing device 510 calculates the target index using the extracted data generated in the process of the latest S130. Here, an index value indicating the magnitude of the damage accumulated in the lock-up clutch 45 is calculated. For example, the processing device 510 calculates the level of damage as an index value indicating the magnitude of damage accumulated in the lock-up clutch 45.

The level of damage is an index value representing the rate of damage accumulated, assuming that the damage of the lock-up clutch 45 gradually accumulates, assuming that the damage resulting in damage is “1”. Here, the damage applied to the lock-up clutch 45 during a certain period of time is calculated based on the slip revolution speed data. The damage applied to the lock-up clutch 45 may be calculated from at least one of the continuous slip time and the predicted temperature value as the feature quantity together with the slip revolution speed. Then, the level of damage that the lock-up clutch 45 is damaged is set to “1”, and the calculated rate of damage is calculated as an index value. By repeating this process, the level of damage, which is the ratio of accumulated damage to damage leading to damage, is calculated. When the level of damage becomes “1”, the damage is caused, and the calculated level of damage is a value from “0” to “1”.

Here, since the level of damage is calculated using the extracted data which is a part of the original data, the processing device 510 converts the calculated level of damage into a size corresponding to the original data, and calculates the level of damage as the index value. For example, when the original data is traveling data for 100,000 hours and the extracted data is traveling data for 20000 hours, the calculated level of damage is multiplied by 5 to obtain the level of damage as the index value.

On the other hand, in S150 process, when it is determined that the error is larger than the threshold (S150: NO), the processing device 510 returns the process to S125. Then, the processing device 510 re-executes the search processing from S125 to S145.

In this way, the processing device 510 repeatedly executes S145 search processing from S125 by changing the settings of the plurality of time windows, and extracts extracted data in which the error becomes equal to or less than the threshold value from the original data. Then, the processing device 510 calculates an index value using the extracted data. After calculating the index, the processing device 510 advances the processing to S170.

In S170 process, the processing device 510 determines whether or not the index value is equal to or greater than a predetermined value. The default value is a value for predicting that damage is more likely to occur based on the fact that the index value is equal to or larger than the default value. For example, “0.9” can be set here, for example, as a default value in the level of damage. In this case, based on the fact that 90% of the fatigue leading to damage has been reached, it is possible to predict that there is a high possibility of damage.

In S170 process, when it is determined that the index value is equal to or greater than the predetermined value (S170: YES), the processing device 510 advances the process to S180. In S180 process, the processing device 510 outputs an index and a failure estimate. Specifically, the processing device 510 transmits the index value and the failure prediction to the information processing terminal 600 that has transmitted the instruction for requesting the analysis.

The failure prediction is, for example, a message indicating that the occurrence of a failure has been predicted. In this way, when the calculated index value is equal to or greater than the predetermined value, the processing device 510 notifies that the occurrence of the failure has been predicted. The failure prediction may be information of a lifetime until a failure occurs. For example, when the level of damage calculated by using the extracted data extracted from the original data for 100,000 hours is the index value, the processing device 510 calculates the traveling time until the level of damage reaches “1” and outputs the calculated traveling time as the information of the life. The information on the life may be converted into the traveling distance based on the traveling distance of 100,000 hours and output.

In S170 process, when it is determined that the index value is less than the predetermined value (S170: NO), the processing device 510 advances the process to S190. In S190 process, the processing device 510 outputs an index. Specifically, the processing device 510 transmits the index value to the information processing terminal 600 that has transmitted the instruction for requesting the analysis.

### Operation of this Embodiment

When S180 or S190 process is executed, the processing device 510 terminates the series of processes.

The data center 500, which is the information processing apparatus of the present embodiment, acquires original data collected and created over a predetermined period using a sensor mounted on the vehicle 10, and calculates the level of damage as an index value indicating the magnitude of damage accumulated in the lock-up clutch 45 of the torque converter 40.

The data center 500 includes a processing device 510 that executes processing. The original data includes data of the slip revolution speed of the lock-up clutch 45 of the torque converter 40 as the feature quantity. The original data further includes at least one data of a continuous slip time and a predicted temperature value as a feature quantity in addition to the slip revolution speed. In the data center 500, the search processing executed by the processing device 510 includes a first step (S120) of calculating, for each feature quantity, a relative frequency distribution in the original data for the feature quantity included in the original data. The search processing includes a second step (S125) of setting a plurality of time windows for cutting out data of a part of the period of the original data such that the period of time of all the time windows is less than the predetermined period of time. The search processing includes a third step (S130) of extracting data from the original data by a plurality of time windows. The search processing includes a fourth step (S140) of calculating, for each feature quantity, the relative frequency distribution in the extracted data obtained by combining all the data cut out by the plurality of time windows. The search processing includes a fifth step (S145) of calculating an error between the relative frequency distribution in the original data and the relative frequency distribution in the extracted data. After executing the first step, the processing device 510 executes a search processing in which the trials from the second step to the fifth step are repeatedly executed by changing the settings of a plurality of time windows. Then, the processing device 510 extracts the extracted data in which the error is equal to or less than the threshold (S150: YES). The processing device 510 calculates an index value using the extracted data in which the error becomes equal to or smaller than the threshold value (S160).

According to the data center 500, it is possible to obtain extracted data in which features of the entire original data including a plurality of feature quantities are captured. The extracted data has a smaller amount of data than the original data and has the same accuracy as the original data. Therefore, the data center 500 can calculate the index value with the same accuracy as in the case of using the original data by using the extracted data.

### Effect of this Embodiment

According to the data center 500 that is the information processing apparatus of the present embodiment, it is possible to extract extracted data that has a smaller data amount than the original data and that can obtain an analysis result equivalent to the original data.

According to the data center 500 that is the information processing apparatus of the present embodiment, it is possible to achieve both reduction in the amount of data and calculation accuracy of the index value.

According to the data center 500 which is the information processing apparatus of the present embodiment, it is possible to calculate the index value in a shorter time than in the case where the original data is used.

The processing device 510 performs clustering, which is machine learning for classifying the data of the sections obtained by dividing the original data into a predetermined number of clusters at regular intervals (S110). Then, in the second step (S125) of the search processing, the processing device 510 sets a plurality of time windows such that the difference between the ratio of each cluster in the extracted data and the ratio of each cluster in the entire original data is equal to or less than the threshold.

A plurality of sections classified into the same cluster are sections having similar characteristics. In the above-described search processing, the setting output from the processing device 510 is a setting in which the difference between the ratio of the entire original data and each cluster is equal to or less than the threshold value, and the extracted data having the relative frequency distribution of each feature quantity close to each other can be extracted.

Therefore, according to the search processing executed by the data center 500, it is possible to find a setting that can obtain extracted data closer to the characteristics of the entire original data.

The processing device 510 terminates the search processing at the point in time when one piece of extracted data whose error becomes equal to or smaller than the threshold value can be extracted, and calculates an index value using the extracted data whose error becomes equal to or smaller than the threshold value. Therefore, the data center 500 can calculate an index value at a point in time when one piece of extracted data whose error becomes equal to or smaller than the threshold value can be extracted, and output the result promptly.

When the calculated index value is equal to or greater than the predetermined value (S170: YES), the processing device 510 notifies that a failure has been predicted. Therefore, the data center 500 can notify the user that the occurrence of the failure has been predicted before the failure occurs.

The processing device 510 calculates a level of damage as an index value. Therefore, the data center 500 can inform the user of how long the delay until the failure is reached.

### Example of Change

The present embodiment can be modified to be implemented as follows. The present embodiment and modifications described below may be carried out in combination within a technically consistent range.

Although the slip revolution speed, the continuous slip time, and the temperature predicted value are exemplified as the feature quantities, the index value may be calculated by further including the data of the foreign matter predicted value of the lock-up clutch 45 in the feature quantity. The foreign matter prediction value is a value predicting that a foreign matter is mixed in the hydraulic oil of the lock-up clutch 45. The control device 70 calculates a predicted foreign matter value from the total travel distance of the vehicle 10 and the oil exchange information. For example, the control device 70 calculates a foreign matter prediction value higher as the traveling distance of the vehicle 10 is longer. The control device 70 resets the predicted foreign matter value when the hydraulic oil of the vehicle 10 is replaced, and calculates the predicted foreign matter value according to the travel distance of the vehicle 10 from the point in time.

In the above embodiment, an example in which the information processing apparatus is embodied as the data center 500 has been described. An example in which the index value is calculated in the data center 500 has been described. On the other hand, the information processing apparatus described above may be embodied as the information processing terminal 600. In this case, the calculation of the index value is executed by the processing device 610 of the information processing terminal 600. The above-described information processing apparatus may be embodied as the control device 70 of the vehicle 10. For example, the calculation of the index value can be executed by the control device 70 of the vehicle 10.

An example has been described in which the data center 500, which is an information processing apparatus, executes extraction of extracted data from original data and calculation of an index value. In contrast, the information processing apparatus may be an apparatus that performs extraction of extracted data from original data. For example, the data center 500 may extract the extracted data from the original data and transmit the extracted data to the information processing terminal 600. In this case, the information processing terminal 600 that has received the extracted data calculates the index value. For example, the control device 70 of the vehicle 10 may extract the extracted data from the original data and transmit the extracted data to the data center 500. In this case, the data center 500 that has received the extracted data calculates the index value.

In the above-described embodiment, an example has been described in which one piece of extracted data is extracted and an index value is calculated. On the other hand, a final index value may be determined by extracting a plurality of pieces of extracted data and using a plurality of index values calculated using the respective pieces of extracted data. For example, the minimum value, the maximum value, the mode value, and the average value are set as final index values. Further, a plurality of index values may be output.

In the above-described embodiment, an example has been described in which, when the index value is equal to or larger than a predetermined value, it is notified that the occurrence of a failure has been predicted. This may be omitted. After the index value is calculated, only S190 processing may be executed, and only the index value may be outputted.
Although the level of damage is exemplified as an example of the index value to be calculated, the index value to be calculated is not limited to the level of damage. The processing device 510 sets a plurality of time windows such that a difference between a ratio of each cluster in the original data and a ratio of each cluster in the extracted data is equal to or smaller than a threshold value. Without such a restriction, the processing device 510 may set a plurality of time windows. In such cases, the processing S110 clustering may be omitted.

The method of determining the setting of the time window in the cut-out pattern may not be random. The trial may be repeated by changing the setting of the time window in the clipping pattern according to a preset rule.

The error calculated in S145 processing is not limited to the mean absolute error MAE. For example, the processing device 510 may calculate a mean square error as an error. The processing device 510 may calculate a root mean square error as an error.

An example using extracted data obtained by combining all extracted data is shown. On the other hand, some of the extracted data may be combined to create extracted data.

What is claimed is:

1. An information processing apparatus that acquires original data, created by collecting over a predetermined period using a sensor installed a vehicle, and extracts data used for calculating a level of damage indicating a magnitude of damage accumulated in a lock-up clutch of a torque converter from the original data, the information processing apparatus comprising a processing device that executes processing, wherein:
the original data includes data of slip revolution speed of the lock-up clutch of the torque converter as a feature quantity;
the processing device executes search processing including
a first step of calculating relative frequency distribution in the original data regrading the feature quantity included in the original data for each of the feature quantities, a second step of setting a plurality of time windows for cutting out data for a part of a period of the original data such that a period obtained by totaling periods of all of the time windows is shorter than the predetermined period,
a third step of cutting out data from the original data using the time windows,
a fourth step of calculating the relative frequency distribution in extracted data obtained by combining the data cut out using the time windows for each of the feature quantities, and
a fifth step of calculating error between the relative frequency distribution in the original data and the relative frequency distribution in the extracted data; and
after the first step is executed, attempts of the second step to the fifth step are repeatedly executed while changing settings of the time windows, and the extracted data in which the error is no greater than a threshold value is extracted.

2. The information processing apparatus according to claim 1, wherein the original data includes continuous slip time regarding the lock-up clutch of the torque converter as the feature quantity.

3. The information processing apparatus according to claim 1, wherein the original data includes a temperature prediction value regarding the lock-up clutch of the torque converter as the feature quantity.

4. The information processing apparatus according to claim 1, wherein:
the processing device executes clustering that is machine learning to classify data in sections, obtained by dividing the original data for each certain period, into a predetermined number of clusters; and
the processing device sets the time windows in the second step such that a difference between a ratio of each cluster in the extracted data and a ratio of each cluster in an entirety of the original data is no greater than a threshold value.

5. The information processing apparatus according to claim 1, wherein the processing device calculates the level of damage using the extracted data in which the error is no greater than the threshold value, and when the level of damage that is calculated is no smaller than a predetermined value, the processing device performs notification notifying that occurrence of a malformation is predicted.
